(19) United States
(12) Patent Application Publication
(10) Pub. No.: US 2024/0410297 A1
(43) Pub. Date: Dec. 12, 2024

(54) EXPANSION TURBINE AND REFRIGERATION DEVICE USING SAME

(71) Applicant: Panasonic Intellectual Property Management Co., Ltd., Kadoma-shi, Osaka (JP)

(72) Inventors: Hidetoshi TAGUCHI, Osaka (JP); Tetsuhide KURAMOTO, Nara (JP); Masaya HONMA, Hyogo (JP); Takumi HIKICHI, Osaka (JP)

(21) Appl. No.: 18/698,583

(22) PCT Filed: Sep. 28, 2022
(86) PCT No.: PCT/JP2022/036324

§ 371 Date: Apr. 4, 2024

(30) Foreign Application Priority Data
Oct. 5, 2021 (JP) 2021-163874

(51) Int. Cl. F01D 25/32; F01D 25/30

(52) U.S. Cl. CPC F01D 25/32; F01D 25/30; F05D 2240/126; F05D 2260/607

(57) ABSTRACT

An expansion turbine 100 of the present disclosure includes: an expansion turbine impeller 10; a turbine housing 20 surrounding the expansion turbine impeller 10 in a circumferential direction to form a flow path of a working fluid; and a turbine diffuser 30 disposed coaxially with the expansion turbine impeller 10 on a discharge side for the working fluid in the turbine housing 20, and the turbine diffuser 30 also serves as a centrifuge.

### TECHNICAL FIELD

The present disclosure relates to an expansion turbine and a refrigeration device using the expansion turbine.

### BACKGROUND ART

Patent Literature 1 discloses a device for removing moisture contained in a steam flow which is the working fluid of a steam turbine. The device includes vanes, a skimmer slot, and straightening vanes. The vanes are disposed downstream of a high pressure turbine and upstream of a low pressure turbine, and generate a swirling flow having an axis parallel to the axial direction of a turbine shaft, in steam discharged from the high pressure turbine. The skimmer slot guides moisture that is caused to collide against an inner wall surface of the device by the centrifugal force caused by the swirling flow. The straightening vanes are members for eliminating the swirling flow.

### CITATION LIST

### Patent Literature

Patent Literature 1: JP H05-187205 A

### SUMMARY OF INVENTION

### Technical Problem

The present disclosure provides a technique for removing condensed water and/or ice pieces from a working fluid while suppressing a decrease in the performance of an expansion turbine.

### Solution to Problem

An expansion turbine of the present disclosure includes:
an expansion turbine impeller;
a turbine housing surrounding the expansion turbine impeller in a circumferential direction to form a flow path of a working fluid; and
a turbine diffuser disposed coaxially with the expansion turbine impeller on a discharge side for the working fluid in the turbine housing, wherein
the turbine diffuser also serves as a centrifuge.

In another aspect, a refrigeration device of the present disclosure includes the above expansion turbine of the present disclosure, wherein the working fluid is air.

### Advantageous Effects of Invention

According to the present disclosure, condensed water and/or ice pieces can be removed from the working fluid while a decrease in the performance of the expansion turbine is suppressed.

### BRIEF DESCRIPTION OF THE DRAWINGS

FIG. 1 is a cross-sectional view of an expansion turbine according to Embodiment 1.

FIG. 2 is a diagram showing velocity triangles in a radial turbine.

FIG. 3A is a diagram representing a velocity triangle at the time when a working fluid flows into an expansion turbine impeller, on a plane.

FIG. 3B is a diagram representing a velocity triangle at the time when the working fluid is discharged from the expansion turbine impeller, on a plane.

FIG. 4A is a cross-sectional view of an expansion turbine according to Embodiment 2.

FIG. 4B is a semi-cross-sectional view of an inner part.

FIG. 4C is a plan view of the inner part.

FIG. 5A is a cross-sectional view of an expansion turbine according to Embodiment 3.

FIG. 5B is a semi-cross-sectional view of an inner part.

FIG. 5C is a plan view of the inner part.

FIG. 6A is a cross-sectional view of an expansion turbine according to Embodiment 4.

FIG. 6B is a plan view of the expansion turbine according to Embodiment 4.

FIG. 6C is a partially enlarged view of FIG. 6A.

FIG. 7A is a cross-sectional view of an expansion turbine according to Embodiment 5.

FIG. 7B is a cross-sectional view of the expansion turbine according to Embodiment 5, taken along a line A-A.

FIG. 8 is a schematic diagram of a refrigeration device according to Embodiment 6.

### DESCRIPTION OF EMBODIMENTS

(Findings Etc. On which the Present Disclosure is Based)

At the time when the inventors came to conceive of the present disclosure, a refrigeration device that has, as a working fluid, air or other gas outputting cold (cold energy), especially cold having a temperature equal to or lower than the freezing point, and that directly uses the working fluid as a cold source, had been known. In this type of refrigeration device, a structure for collecting condensed water and/or ice pieces was provided on a flow path between a freezer and a heat exchanger. With this structure, water vapor contained in the working fluid can be prevented from condensing during the thermodynamic process of a refrigeration cycle and adhering in a frost-like state to inner wall surfaces, etc., of the freezer, etc., which is the output destination of the cold. Accordingly, the function of the refrigeration device can be maintained even at the time when low-temperature cold is outputted.

However, if an additional structure for collecting condensed water and/or ice pieces is provided, the flow of the working fluid is impeded and the performance of the refrigeration device is decreased, and also the economic efficiency is poor. The inventors who realized this fact have come to conceive of using the flow of a working fluid to remove condensed water and/or ice pieces in the working fluid, and have completed an expansion turbine that can provide excellent convenience and economic efficiency to a refrigeration device.

The present disclosure provides a technique for reducing heat transferred from a heat generation source such as a bearing to a working fluid through a rotating shaft and a fluid element while maintaining the rotational stability of the rotating shaft.

Hereinafter, embodiments will be described in detail with reference to the drawings. However, more detailed description than necessary may be omitted. For example, detailed description of a well-known matter or overlapping description of substantially the same structure may be omitted.

### Embodiment 1

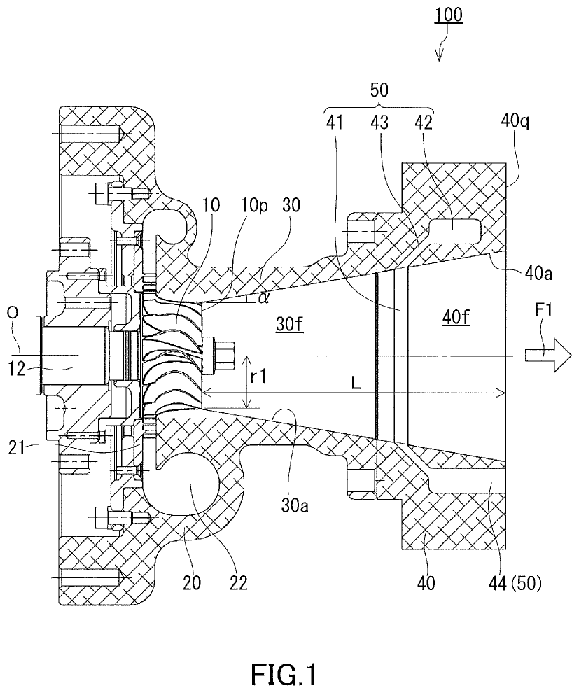

Hereinafter, Embodiment 1 will be described with reference to FIG. 1 to FIG. 3B.

### [1-1. Configuration]

FIG. 1 is a cross-sectional view of an expansion turbine 100 according to Embodiment 1. The expansion turbine 100 includes an expansion turbine impeller 10, a turbine housing 20, and a turbine diffuser 30. The turbine housing 20 surrounds the expansion turbine impeller 10 in the circumferential direction to form a flow path of a working fluid. The turbine diffuser 30 is disposed coaxially with the expansion turbine impeller 10 on the discharge side for the working fluid in the turbine housing 20. The turbine diffuser 30 also serves as a centrifuge.

The expansion turbine 100 can separate condensed water and/or ice pieces contained in the working fluid from a main flow F1 of the working fluid, by using a swirling component, of the working fluid, having an axis parallel to the flow direction of the working fluid, at the downstream of the expansion turbine impeller 10, that is, at the turbine diffuser 30. Therefore, when the expansion turbine 100 is used in the final process of a cold generation cycle, condensed water and/or ice pieces are less likely to be discharged from the expansion turbine 100. In the case where components such as a pipe and a freezer are disposed downstream of the expansion turbine 100, frost formation on the inner wall surfaces of these components can be suppressed. Depending on the case, a mechanism for separating condensed water and/or ice pieces can be omitted or simplified, thereby reducing the cost of a refrigeration device using the expansion turbine 100. By suppressing frost formation, the downtime of the refrigeration device for defrosting can also be reduced, thereby improving convenience.

Furthermore, there is no need to add a member that impedes the pressure recovery function of the turbine diffuser 30 (such as those described in Patent Literature 1), so that the pressure loss of the working fluid can be suppressed. Accordingly, the efficiency of the expansion turbine 100 is improved.

In the following, the “condensed water and/or ice pieces” are referred to simply as “condensed water”. By the technique of the present disclosure, condensed water is mainly collected and discharged to the outside of the expansion turbine 100. Depending on the temperature, ice pieces may be mixed in the condensed water, and ice pieces may be mainly collected.

The expansion turbine impeller 10 is attached to a shaft 12, and rotates with the shaft 12.

The turbine housing 20 has a volute 22 including an inlet of the expansion turbine 100. A turbine nozzle 21 is disposed around the expansion turbine impeller 10. The volute 22 and the turbine nozzle 21 form a flow path from the inlet of the expansion turbine 100 to the expansion turbine impeller 10.

The turbine diffuser 30 is a tubular member extending in a direction parallel to a rotation axis O from a position corresponding to a downstream end 10p of the expansion turbine impeller 10. The turbine diffuser 30 has an internal flow path 30f. An inner circumferential surface 30a of the turbine diffuser 30 is inclined with respect to the rotation axis O. The cross-sectional area of the internal flow path 30f continuously increases toward the downstream side in the flow direction of the working fluid. In the turbine diffuser 30, the velocity of the working fluid gradually decreases and the pressure of the working fluid gradually recovers. The turbine housing 20 and the turbine diffuser 30 may be integrated. That is, the turbine housing 20 and the turbine diffuser 30 may be a single part.

The turbine housing 20 and the turbine diffuser 30 are disposed coaxially with the expansion turbine impeller 10. The rotation axis O of the expansion turbine impeller 10 passes through the centers of the turbine housing 20 and the turbine diffuser 30. The rotation axis O of the expansion turbine impeller 10 is parallel to the horizontal direction, for example.

Specifically, the expansion turbine 100 is a radial turbine. When the technique of the present disclosure is applied to a radial turbine, condensed water can be efficiently removed from a working fluid.

The type of working fluid is not particularly limited. The working fluid is, for example, air. In the case where air is the working fluid, low-temperature air produced by the expansion turbine 100 is supplied directly to a target space such as a freezer (see Embodiment 6).

The expansion turbine 100 further includes a separation flow path 50 in order to serve as a centrifuge. In the present embodiment, the expansion turbine 100 further has a flow path member 40 contiguous with the turbine diffuser 30. The separation flow path 50 is provided in the flow path member 40. The flow path member 40 is also disposed coaxially with the expansion turbine impeller 10. An inner circumferential surface 40a of the flow path member 40 is also inclined with respect to the rotation axis O. The cross-sectional area of an internal flow path 40f of the flow path member 40 also continuously increases toward the downstream side in the flow direction of the working fluid. That is, in the present embodiment, the flow path member 40 can be a portion of a diffuser. However, it is not essential that the flow path member 40 has the function of a diffuser. The cross-sectional area of the internal flow path 40f of the flow path member 40 may be constant along the flow direction of the working fluid. In other words, in the cross-section of FIG. 1, the inner circumferential surface 40a of the flow path member 40 may be parallel to the rotation axis O. The flow path member 40 may be omitted.

An inclination angle α of the inner circumferential surface 30a with respect to the rotation axis O is equal to an inclination angle of the inner circumferential surface 40a with respect to the rotation axis O. The inclination angle is, for example, in the range of 7.5 degrees to 15 degrees. No step is provided between the inner circumferential surface 30a and the inner circumferential surface 40a.

The separation flow path 50 has an inlet 41 opening in the inner circumferential surface 40a of the flow path member 40, and communicates with the outside of the expansion turbine 100. The separation flow path 50 is a flow path different from the internal flow path 30f and the internal flow path 40f. Condensed water flows into the separation flow path 50 through the inlet 41. In the case where the flow path member 40 is omitted, the inlet 41 of the separation flow path 50 may open in the inner circumferential surface 30a of the turbine diffuser 30. The separation flow path 50 serves to collect condensed water separated from the main flow F1 of the working fluid and discharge the condensed water to the outside. The separation flow path 50 allows condensed water to be continuously discharged to the outside. The turbine diffuser 30 and the separation flow path 50 cooperate to perform the function of a centrifuge.

The “outside of the expansion turbine 100” means the outside of a device using the expansion turbine 100, e.g., a refrigeration device. The outside of the expansion turbine 100 is, for example, an external atmosphere or drain to which separated condensed water should be discharged.

The inlet 41 of the separation flow path 50 is located, for example, in a range described below. When both the internal flow path 30f and the internal flow path 40f have a continuously increasing cross-sectional area, that is, when the flow path member 40 has the function of a diffuser, the inlet 41 is located in a range downstream of the midpoint (L/2 position) of a total length L of the internal flow path 30f and the internal flow path 40f. If the inlet 41 is provided at such a position, condensed water can be efficiently collected while a decrease in the performance of the expansion turbine 100 is suppressed. When the radius of the expansion turbine impeller 10 at the downstream end 10p in the flow direction of the working fluid is r1, the inlet 41 may be provided in the range of 1.4 r1 to 4.5 r1 with the position of the downstream end 10p as a reference (=0).

The size of the inlet 41 of the separation flow path 50 is not particularly limited. The size of the inlet 41 can be adjusted such that the inflow amount of the working fluid can be reduced while condensed water is sufficiently collected.

In the present embodiment, the inlet 41 is provided over 360 degrees in the circumferential direction around the rotation axis O. That is, the inlet 41 has an annular shape along the inner circumferential surface 40a (or the inner circumferential surface 30a). With such a configuration, condensed water can be reliably collected. However, the shape of the inlet 41 is not particularly limited. The inlet 41 may be divided into a plurality of portions. Each of the plurality of portions may have an arc shape or may be circular in a plan view.

The separation flow path 50 further has a separation chamber 42, an upstream portion 43, and a downstream portion 44. The separation chamber 42 is located radially outward of the inner circumferential surface 40a of the flow path member 40 (or the inner circumferential surface 30a of the turbine diffuser 30). The upstream portion 43 is a portion allowing communication between the inlet 41 and the separation chamber 42. The downstream portion 44 is a portion allowing communication between the separation chamber 42 and the outside of the expansion turbine 100. With such a configuration, when condensed water flows into the separation flow path 50 through the inlet 41 together with a small amount of the working fluid, the working fluid collides against the inner surface of the separation chamber 42. Accordingly, the working fluid undergoes a further separation action, so that the condensed water can be reliably collected and discharged.

The flow path cross-sectional area (maximum portion) of the upstream portion 43 is smaller than the flow path cross-sectional area (minimum portion) of the separation chamber 42. The flow path cross-sectional area of the upstream portion 43 is the area of the upstream portion 43 in any cross-section passing through the upstream portion 43 and perpendicular to the rotation axis O. Similarly, the flow path cross-sectional area of the separation chamber 42 is the area of the separation chamber 42 in any cross-section passing through the separation chamber 42 and perpendicular to the rotation axis O. With such a configuration, the flow of the working fluid is less likely to be decelerated at the upstream portion 43.

The magnitude of the flow path cross-sectional area of the downstream portion 44 is not particularly limited. In the present embodiment, the flow path cross-sectional area of the downstream portion 44 is smaller than the flow path cross-sectional area of the separation chamber 42. The flow path cross-sectional area of the downstream portion 44 is the area of the downstream portion 44 in any cross-section passing through the downstream portion 44 and perpendicular to the rotation axis O.

The separation chamber 42 has an annular shape coaxial with the expansion turbine impeller 10. With such a configuration, condensed water can be collected over the entire circumference of the inner circumferential surface 30a of the turbine diffuser 30 or the inner circumferential surface 40a of the flow path member 40. Therefore, condensed water can be collected more reliably. This makes it possible to sufficiently suppress frost formation on the inner wall surfaces of components disposed downstream of the expansion turbine 100.

The upstream portion 43 extends obliquely from the inlet 41 toward the separation chamber 42. In the present embodiment, in the direction parallel to the rotation axis O, the distance from the expansion turbine impeller 10 to the inlet 41 is shorter than the distance from the expansion turbine impeller 10 to the separation chamber 42. Therefore, the upstream portion 43 extends in a direction inclined with respect to the rotation axis O and away from the rotation axis O. In the cross-section of FIG. 1, an inclination angle of the upstream portion 43 with respect to the rotation axis O is, for example, 30 degrees to 60 degrees. The downstream portion 44 opens in an end surface 40q of the flow path member 40 (or an end surface of the turbine diffuser 30). The downstream portion 44 communicates with the separation chamber 42 at a lowermost portion in the vertical direction. Accordingly, condensed water is smoothly collected in the downstream portion 44 from the separation chamber 42.

The downstream portion 44 may extend radially outward. The downstream portion 44 may open in the outer circumferential surface of the flow path member 40 or the outer circumferential surface of the turbine diffuser 30. For example, the downstream portion 44 may extend vertically downward. In this case, condensed water is easily collected in the downstream portion 44.

### [1-2. Operation]

The operation and the action of the expansion turbine 100 configured as described above will be described below.

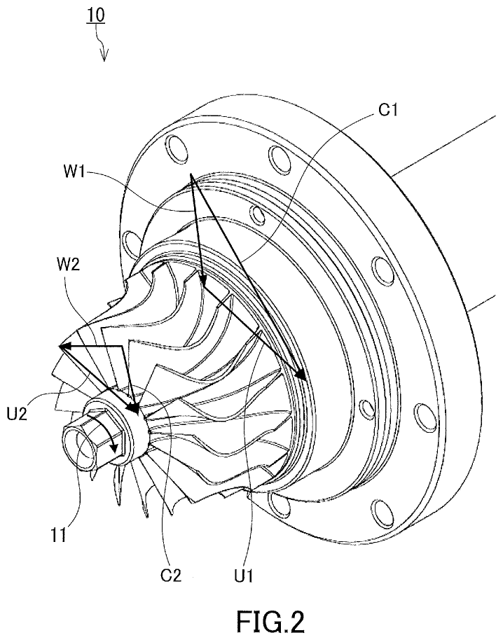

FIG. 2 is a diagram showing velocity triangles in the radial turbine. In the radial turbine, the working fluid flows into the expansion turbine impeller 10 at an inflow relative velocity W1 from an outer circumferential portion of the expansion turbine impeller 10, passes through an inter-blade flow path of the expansion turbine impeller 10, and is discharged at a discharge absolute velocity C2 toward the turbine diffuser 30. The expansion turbine impeller 10 is rotated in a rotation direction 11 by an impulse to the expansion turbine impeller 10 caused by the working fluid flowing thereinto at the inflow relative velocity W1 and a reaction given to the expansion turbine impeller 10 when the working fluid is discharged at a discharge relative velocity W2.

When the expansion turbine impeller 10 rotates, the expansion turbine impeller 10 has a circumferential velocity U1 at a position at which the working fluid flows into the expansion turbine impeller 10. The expansion turbine impeller 10 has a circumferential velocity U2 at a position at which the working fluid is discharged from the expansion turbine impeller 10. Therefore, the working fluid flows into the expansion turbine impeller 10 at the inflow relative velocity W1 which is the combined velocity of the circumferential velocity U1 and an inflow absolute velocity C1. When the working fluid is discharged from the expansion turbine impeller 10, the working fluid is discharged from the inter-blade flow path of the expansion turbine impeller 10 at the discharge relative velocity W2. Therefore, the working fluid is discharged from the expansion turbine impeller 10 at the discharge absolute velocity C2, which is the combined velocity of the circumferential velocity U2 and the discharge relative velocity W2, in a discharge direction that forms an angle with the discharge relative velocity W2. A vector diagram representing the relationship between the flow directions of the working fluid at the time of inflow into the expansion turbine impeller 10 and at the time of discharge from the expansion turbine impeller 10 as described above is referred to as a velocity triangle. The velocity triangle is one of the design factors that determine output and performance in designing of an expansion turbine.

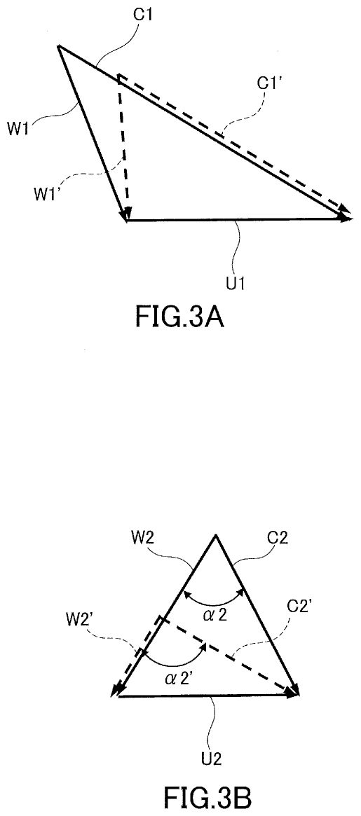

FIG. 3A is a diagram representing a velocity triangle at the time when the working fluid flows into the expansion turbine impeller 10, on a plane. FIG. 3B is a diagram representing a velocity triangle at the time when the working fluid is discharged from the expansion turbine impeller 10, on a plane.

As shown in FIG. 3A and FIG. 3B, the working fluid flows into the expansion turbine impeller 10 at the inflow relative velocity W1 from the outer circumferential portion of the expansion turbine impeller 10, passes through the inter-blade flow path of the expansion turbine impeller 10, and is discharged at the discharge absolute velocity C2 toward the turbine diffuser 30. The expansion turbine impeller 10 is rotated in the rotation direction 11 by the impulse to the expansion turbine impeller 10 caused by the working fluid flowing thereinto at the inflow relative velocity W1 and the reaction given to the expansion turbine impeller 10 when the working fluid is discharged at the discharge relative velocity W2.

When the expansion turbine impeller 10 rotates, the expansion turbine impeller 10 has the circumferential velocity U1 at the position at which the working fluid flows into the expansion turbine impeller 10. The expansion turbine impeller 10 has the circumferential velocity U2 at the position at which the working fluid is discharged from the expansion turbine impeller 10. Therefore, the working fluid flows into the expansion turbine impeller 10 at the inflow relative velocity W1 which is the combined velocity of the circumferential velocity U1 and the inflow absolute velocity C1. When the working fluid is discharged from the expansion turbine impeller 10, the working fluid is discharged from the inter-blade flow path of the expansion turbine impeller 10 at the discharge relative velocity W2. Therefore, the working fluid is discharged from the expansion turbine impeller 10 at the discharge absolute velocity C2, which is the combined velocity of the circumferential velocity U2 and the discharge relative velocity W2, in a discharge direction that forms a discharge flow angle α2 with respect to the discharge relative velocity W2.

The case where the temperature of the working fluid decreases in the expansion turbine 100 having such a flow direction relationship, will be considered. As the temperature of the working fluid flowing into the expansion turbine impeller 10 decreases, the density of the working fluid increases. Unless a throttle mechanism (turbine nozzle) for spraying the working fluid toward the expansion turbine impeller 10 is of a variable type in which the throttle area thereof is varied in accordance with the density of the working fluid, the inflow absolute velocity C1 decreases and changes to an inflow absolute velocity C1′ at low temperature. Therefore, if the circumferential velocity U1 is constant, the inflow relative velocity W1 changes to an inflow relative velocity W1′ at low temperature. Similarly, on the discharge side of the expansion turbine impeller 10, the density of the working fluid decreases as the temperature of the working fluid decreases, so that the discharge relative velocity W2 changes to a discharge relative velocity W2′ at low temperature. The discharge absolute velocity C2 changes to a discharge absolute velocity C2′ at low temperature. At that time, the discharge flow angle α2 which is an angle between the discharge relative velocity W2 and the discharge absolute velocity C2 changes to a discharge flow angle α2′ at low temperature which a larger angle (α2′>α2). That is, as the temperature of the working fluid decreases, the inclination angle of the flow direction of the working fluid with respect to the rotation axis O increases, and the intensity of a swirling component of the flow of the working fluid also increases.

An expansion turbine may be used for the purpose of decreasing the temperature of the working fluid. For example, the purpose may be to decrease the temperature of a space located downstream of the expansion turbine. One method for decreasing the temperature of the working fluid to a desired temperature is to repeat causing the working fluid to flow into the downstream space, sucking and compressing the working fluid from the downstream space, and re-expanding the compressed working fluid in the expansion turbine. As the temperature of the working fluid decreases, the swirling component of the flow of the working fluid discharged from the expansion turbine impeller 10 increases continuously. In particular, if the temperature of the working fluid decreases to a temperature equal to or lower than a dew point corresponding to the pressure of the working fluid, the working fluid discharged from the expansion turbine impeller 10 contains condensed water. If the temperature of the working fluid falls below the freezing point, the flow of the working fluid can contain ice pieces. If the working fluid is air and the temperatures of the air and condensed water (and/or ice pieces) are equal to each other, there is a density difference of about 10³ times between both. Therefore, in a flow area where the air and the condensed water (and/or ice pieces) have the same swirling velocity, a stronger inertia force acts on the condensed water (and/or ice pieces) in the tangential direction of the swirling component than on the air.

The condensed water is discharged from the inter-blade flow path of the expansion turbine impeller 10 together with the working fluid. Then, the working fluid containing the condensed water flows downstream while having a flow component distributed in the vicinity of the inner circumferential surface 30a of the turbine diffuser 30 and directed in the tangential direction of the inner circumferential surface 30a. In the expansion turbine 100 of the present embodiment, the turbine diffuser 30 also serves as a centrifuge. Specifically, the expansion turbine 100 includes the separation flow path 50. The working fluid containing condensed water is concentrated in the vicinity of the inner circumferential surface 30a of the turbine diffuser 30. The condensed water contained in the working fluid is collected together with a part of the working fluid in the separation chamber 42 through the inlet 41 of the separation flow path 50, and is discharged to the outside of the expansion turbine 100 through the downstream portion 44 of the separation flow path 50. Accordingly, the condensed water can be separated from the main flow F1 of the working fluid.

### [1-3. Effects Etc.]

As described above, in the present embodiment, the turbine diffuser 30 also serves as a centrifuge. Accordingly, condensed water can be removed from the working fluid while a decrease in the performance of the expansion turbine 100 is suppressed.

In the present embodiment, the expansion turbine 100 may further include the separation flow path 50 which is a flow path having the inlet 41 opening in the inner circumferential surface 30a of the turbine diffuser 30 or the inner circumferential surface 40a of the flow path member 40 contiguous with the turbine diffuser 30 and which communicates with the outside of the expansion turbine 100. The separation flow path 50 allows condensed water to be continuously discharged to the outside.

In the present embodiment, the separation flow path 50 may further have the separation chamber 42 placed radially outward of the inner circumferential surface 30a of the turbine diffuser 30 or the inner circumferential surface 40a of the flow path member 40, the upstream portion 43 allowing communication between the inlet 41 and the separation chamber 42, and the downstream portion 44 allowing communication between the separation chamber 42 and the outside of the expansion turbine 100. With such a configuration, the working fluid undergoes a further separation action, so that condensed water can be reliably collected and discharged.

In the present embodiment, the separation chamber 42 may have an annular shape coaxial with the expansion turbine impeller 10. With such a configuration, condensed water can be collected over the entire circumference of the inner circumferential surface 30a of the turbine diffuser 30 or the inner circumferential surface 40a of the flow path member 40.

### Embodiment 2

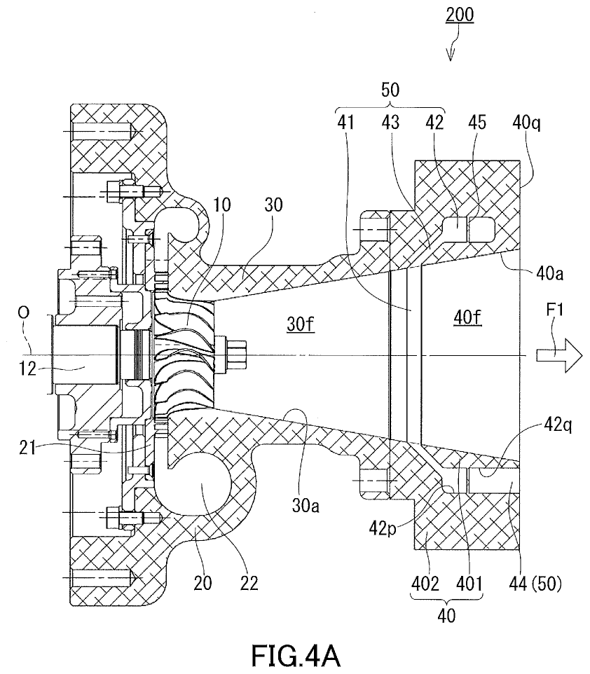

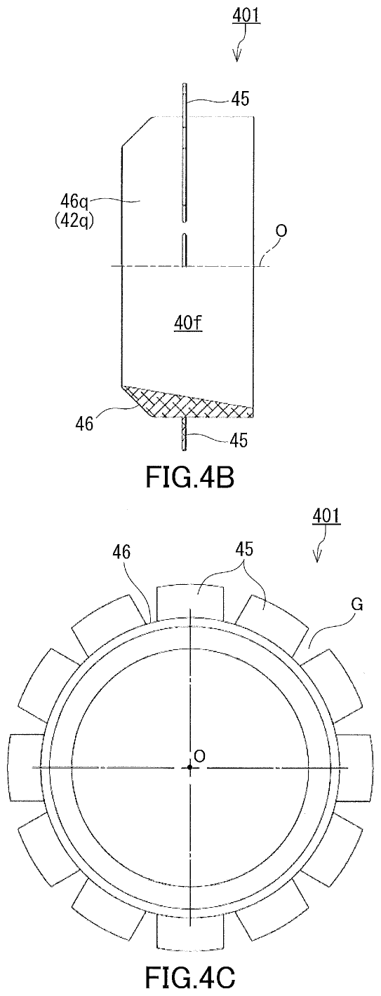

Hereinafter, Embodiment 2 will be described with reference to FIG. 4A, FIG. 4B, and FIG. 4C.

### [2-1. Configuration]

FIG. 4A is a cross-sectional view of an expansion turbine 200 according to Embodiment 2. The expansion turbine 200 further includes a baffle 45 disposed inside the separation chamber 42. The baffle 45 promotes separation of condensed water from the working fluid. Except for the baffle 45, the configuration of the expansion turbine 200 is the same as the configuration of the expansion turbine 100 of Embodiment 1.

Specifically, the expansion turbine 200 includes a plurality of baffles 45. The plurality of baffles 45 are disposed in the annular separation chamber 42 along the circumferential direction around the rotation axis O. The plurality of baffles 45 may be disposed in the separation chamber 42 at equal angular intervals. However, a single baffle 45 may be disposed in the separation chamber 42.

The flow path member 40 has an inner part 401 and an outer part 402. The outer part 402 is a part having a mortar-shaped inner circumferential surface. The inner part 401 is a tubular part having the internal flow path 40f. The inner part 401 is fitted to the outer part 402. The shapes of the inner part 401 and the outer part 402 are determined such that when the inner part 401 is fitted to the outer part 402, the separation flow path 50 is ensured therebetween.

FIG. 4B is a semi-cross-sectional view of the inner part 401. FIG. 4C is a plan view of the inner part 401. The inner part 401 has a tubular body 46. Each of the plurality of baffles 45 extends radially outward from an outer circumferential surface 46q of the tubular body 46. The plurality of baffles 45 are disposed on the outer circumferential surface 46q of the tubular body 46 along the circumferential direction around the rotation axis O. A gap G is ensured between the baffles 45 adjacent to each other in the circumferential direction. The working fluid flows toward the downstream of the separation flow path 50 through the gap G. A main surface of each baffle 45 is perpendicular to the rotation axis O. The “main surface” means a surface having the widest area.

Typically, the baffles 45 are integrally formed on the tubular body 46. That is, each baffle 45 is a portion of the inner part 401. However, each baffle 45 may be another part that can be separated from the inner part 401. Alternatively, each baffle 45 may be integrally formed on the outer part 402.

As shown in FIG. 4A, each baffle 45 extends from a second inner surface 42q of the separation chamber 42 to a first inner surface 42p of the separation chamber 42. Accordingly, condensed water can be collected more reliably. The first inner surface 42p and the second inner surface 42q are each a surface along the circumferential direction around the rotation axis O of the expansion turbine impeller 10. The distance from the rotation axis O to the second inner surface 42q is shorter than the distance from the rotation axis O to the first inner surface 42p. That is, the first inner surface 42p is an inner surface located on the radially outer side. The second inner surface 42q is an inner surface located on the radially inner side. The second inner surface 42q is a portion of the outer circumferential surface 46q of the tubular body 46 of the inner part 401. The first inner surface 42p is a portion of the inner circumferential surface of the outer part 402. The first inner surface 42p and the second inner surface 42q face each other in the radial direction.

### [2-2. Operation]

The operation and the action of the expansion turbine 200 configured as described above will be described below.

As described in Embodiment 1, condensed water flows into the separation flow path 50 through the inlet 41 together with a part of the working fluid. The condensed water contained in the working fluid collides against the baffles 45 in the separation chamber 42. Accordingly, separation of the condensed water from the working fluid is promoted. The separated condensed water is collected in the downstream portion 44 of the separation flow path 50 by the pressure in the separation chamber 42 and gravity and discharged to the outside of the expansion turbine 200.

In the separation chamber 42, the working fluid containing condensed water collides against the baffles 45, and the flow direction thereof is sharply changed. Since there is a density difference between the working fluid and the condensed water, there is also a difference between the inertia force acting on the working fluid and the inertia force acting on the condensed water. Since there is a difference in inertia force, there is also a difference in flow pattern and flow direction. In particular, the condensed water having a larger inertia force collides and adheres to the surfaces of the baffles 45 or the inner surface of the separation chamber 42. As a result, the velocity of the condensed water decreases rapidly. On the other hand, since the density of the working fluid in the gas phase is low, the inertia force acting on the working fluid is also small. Therefore, a significant decrease in the velocity of the working fluid is less likely to occur. Due to the velocity difference between the working fluid and the condensed water, the working fluid and the condensed water are separated immediately after flowing into the separation chamber 42. That is, the condensed water can be further separated from the working fluid that has flowed into the separation chamber 42. The condensed water can be sufficiently collected from the working fluid and discharged to the outside. This makes it possible to further suppress frost formation on the inner wall surfaces of components disposed downstream of the expansion turbine 200. The condensed water is carried to the downstream portion 44 by the pressure in the separation chamber 42 and gravity and discharged to the outside of the expansion turbine 200.

### [2-3. Effects Etc.]

In the present embodiment, the expansion turbine 200 may further include the baffle 45 disposed inside the separation chamber 42. The baffle 45 promotes separation of condensed water from the working fluid. Condensed water can be further separated from the working fluid that has flowed into the separation chamber 42.

### Embodiment 3

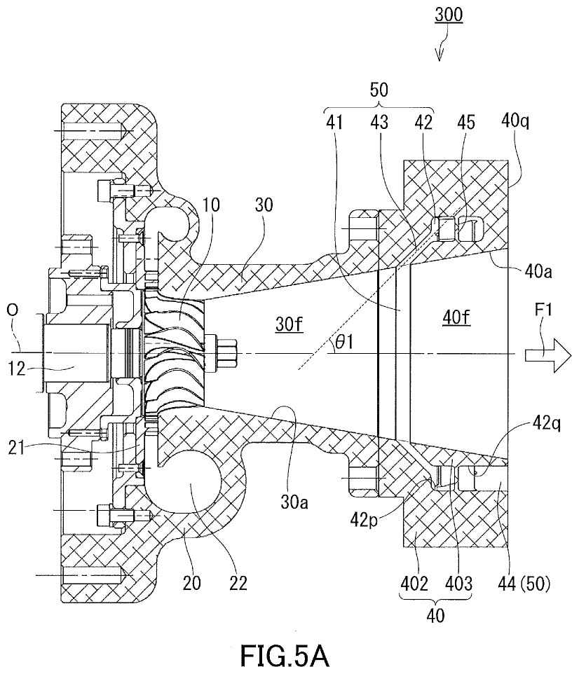

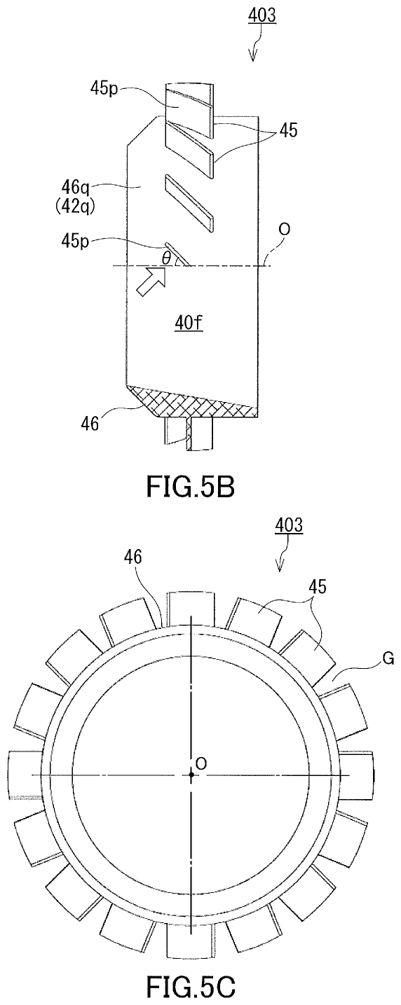

Hereinafter, Embodiment 3 will be described with reference to FIG. 5A, FIG. 5B, and FIG. 5C.

### [3-1. Configuration]

FIG. 5A is a cross-sectional view of an expansion turbine 300 according to Embodiment 3. FIG. 5B is a semi-cross-sectional view of an inner part 403. FIG. 5C is a plan view of the inner part 403. The expansion turbine 300 includes baffles 45 disposed inside the separation chamber 42. The baffles 45 promote separation of condensed water from the working fluid. Each baffle 45 has a main surface 45p inclined with respect to the rotation axis O of the expansion turbine impeller 10. With such a configuration, the working fluid that has reached the separation chamber 42 through the upstream portion 43 collides against each baffle 45 at an angle close to an angle perpendicular to the baffle 45. Therefore, separation of condensed water from the working fluid can be further promoted. Except for the angle of each baffle 45, the configuration of the expansion turbine 300 is the same as the configuration of the expansion turbine 200 of Embodiment 2.

The flow path member 40 has the inner part 403 and an outer part 402. The structure of the outer part 402 is as described in Embodiment 2. The structure of the inner part 403 is as described in Embodiment 2, except for the angle of each baffle 45.

As shown in FIG. 5B, when viewed in a direction perpendicular to the rotation axis O of the expansion turbine impeller 10, an angle θ between the rotation axis O and the main surface 45p of the baffle 45 is in the range of 45 degrees or more and less than 90 degrees. If the angle θ is in such a range, the main surface 45p can be directly opposed to the upstream portion 43 of the separation flow path 50. The working fluid containing condensed water can collide against the baffle 45 at an angle close to an angle perpendicular to the baffle 45. As a result, separation of condensed water from the working fluid can be further promoted.

The angle θ of the baffle 45 may be determined in accordance with an angle θ1 of the upstream portion 43 of the separation flow path 50. The angle θ1 of the upstream portion 43 is an angle between a direction in which the upstream portion 43 extends and the rotation axis O, as shown in the cross-section of FIG. 5A. When the angle θ and the angle θ1 are equal to each other, the working fluid containing condensed water can collide perpendicularly against the main surface of the baffle 45. Therefore, with the angle θ1 as a reference, the angle θ may satisfy θ=θ1±5°.

### [3-2. Operation]

The operation and the action of the expansion turbine 300 configured as described above will be described below.

As described in Embodiment 1, condensed water flows into the separation flow path 50 through the inlet 41 together with a part of the working fluid. The working fluid containing the condensed water has a swirling component after flowing into the separation chamber 42. As shown by an arrow in FIG. 5B, the working fluid containing the condensed water collides against the main surface 45p of the baffle 45, which is inclined at the angle θ, at an angle perpendicular to the main surface 45p or at an angle close to the angle perpendicular to the main surface 45p. When the working fluid collides against the baffle 45, the flow direction of the working fluid is sharply changed to a direction along the main surface 45p of the baffle 45. Meanwhile, the inertia force acting on the condensed water is sufficiently larger than the inertia force acting on the working fluid. Therefore, the change of the flow direction of the condensed water is slow. As a result, after colliding against the main surface 45p of the baffle 45, the condensed water is carried to the downstream portion 44 along the baffle 45, the inner surface 42p of the separation chamber 42, and the inner surface 42q of the separation chamber 42 at a velocity different from that of the working fluid, mainly by the pressure in the separation chamber 42 and gravity. The condensed water is then discharged to the outside of the expansion turbine 300. The rotation direction of the expansion turbine impeller 10 is defined such that a flow of the working fluid is formed in the direction shown by the arrow in FIG. 3B. In this case, the effect of the baffle 45 is most enhanced. However, the relationship between the inclination direction of the baffle 45 and the rotation direction of the expansion turbine impeller 10 is not limited.

### [3-3. Effects Etc.]

In the present embodiment, each baffle 45 may have the main surface 45p inclined with respect to the rotation axis O of the expansion turbine impeller 10. With such a configuration, separation of condensed water from the working fluid can be further promoted.

In the present embodiment, when viewed in the direction perpendicular to the rotation axis O of the expansion turbine impeller 10, the angle θ between the rotation axis O and the main surface 45p may be in the range of 45 degrees or more and less than 90 degrees. With such a configuration, separation of condensed water from the working fluid can be further promoted.

### Embodiment 4

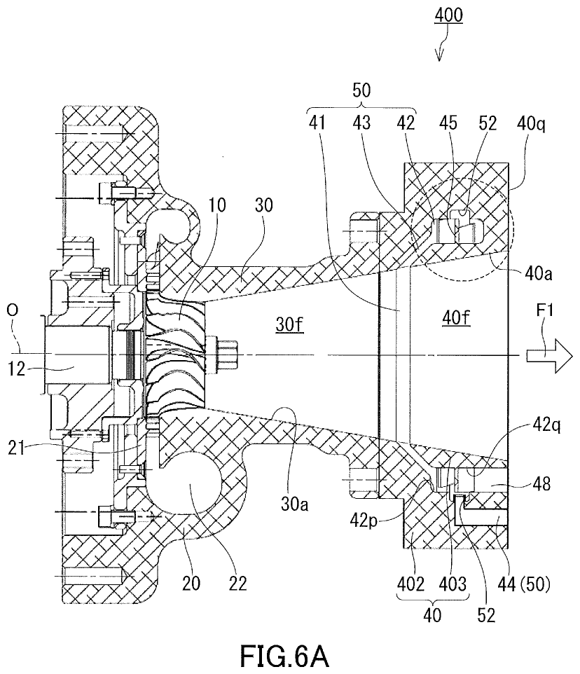

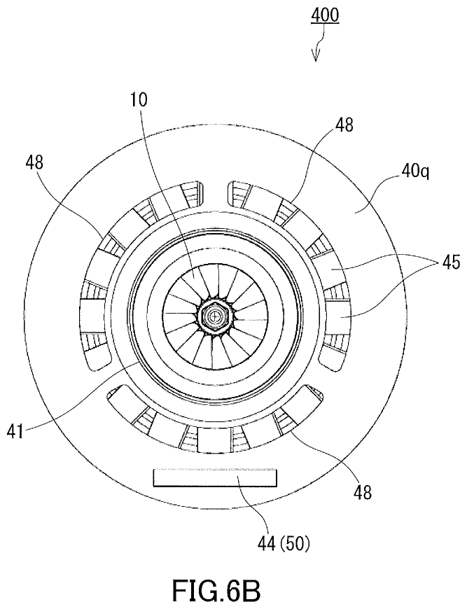

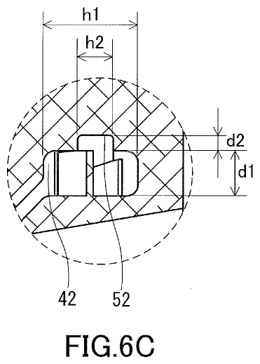

Hereinafter, Embodiment 4 will be described with reference to FIG. 6A and FIG. 6B.

### [4-1. Configuration]

FIG. 6A is a cross-sectional view of an expansion turbine 400 according to Embodiment 4. FIG. 6B is a plan view of the expansion turbine 400 according to Embodiment 4. The plan view of FIG. 6B is a plan view of the expansion turbine impeller 10 as viewed from the downstream side. In the expansion turbine 400, the separation chamber 42 has an annular or arcuate groove 52 provided on the first inner surface 42p. As described with reference to FIG. 4A, the first inner surface 42p is an inner surface located on the radially outer side. At the groove 52, the downstream portion 44 of the separation flow path 50 is connected to the separation chamber 42. With such a configuration, condensed water is easily collected in the groove 52. The condensed water flows along the groove 52 and is discharged to the outside of the expansion turbine 400 through the downstream portion 44 of the separation flow path 50.

For example, the groove 52 overlaps each baffle 45 in the direction parallel to the rotation axis O. In this case, condensed water adhering to the baffle 45 is easily collected in the groove 52. The condensed water collected in the groove 52 flows downward along the groove 52 and is discharged to the outside through the downstream portion 44. Even if each baffle 45 is omitted, a certain effect by the groove 52 can be expected.

FIG. 6C is a partially enlarged view of FIG. 6A. The depth of the groove 52 and the width of the groove 52 are not particularly limited. In an example, a depth d2 of the groove 52 with respect to a maximum dimension d1 of the separation chamber 42 in the direction perpendicular to the rotation axis O may be adjusted so as to satisfy (0.4×d1)≤d2≤(0.8×d1). A width w2 of the groove 52 with respect to a maximum dimension w1 of the separation chamber 42 in the direction parallel to the rotation axis O may be adjusted so as to satisfy (0.2×w1)≤w2≤(0.6×w1). The depth of the groove 52 means the depth of the groove 52 in the direction perpendicular to the rotation axis O. The width of the groove 52 means the width of the groove 52 in the direction parallel to the rotation axis O.

The center position of the groove 52 in the direction parallel to the rotation axis O may coincide with the center position of the separation chamber 42 in the direction parallel to the rotation axis O. The center position of the groove 52 in the direction parallel to the rotation axis O may coincide with the center position of each baffle 45 in the direction parallel to the rotation axis O. Accordingly, condensed water can be efficiently separated from the working fluid while the pressure loss of the working fluid is suppressed.

The downstream portion 44 of the separation flow path 50 is connected to a lowermost portion of the separation chamber 42 in the vertical direction. Therefore, condensed water collected in the groove 52 smoothly flows into the downstream portion 44.

As shown in FIG. 6B, the downstream portion 44 opens in the end surface 40q of the flow path member 40. In the case where the flow path member 40 is omitted, the downstream portion 44 may open in the end surface of the turbine diffuser 30. The downstream portion 44 may extend radially outward. The downstream portion 44 may open in the outer circumferential surface of the flow path member 40 or the outer circumferential surface of the turbine diffuser 30.

The expansion turbine 400 further includes a return flow path 48. The return flow path 48 serves to merge the working fluid that has flowed into the separation flow path 50, into the main flow F1 of the working fluid. With the return flow path 48, cold does not have to be discarded to the outside, and thus the efficiency of the expansion turbine 400 is improved. The return flow path 48 may be provided, for example, in the expansion turbine 100, 200, or 300 of another embodiment.

As shown in FIG. 6B, the return flow path 48 opens in the end surface 40q of the flow path member 40. That is, the return flow path 48 opens toward the separation chamber 42 at the downstream of the baffles 45. With such a configuration, the working fluid from which condensed water is sufficiently removed can be returned to the main flow F1.

In the case where the flow path member 40 is omitted, the return flow path 48 may open in the end surface of the turbine diffuser 30. The return flow path 48 has an arc shape along the circumferential direction of the internal flow paths 30f and 40f in a plan view. In the present embodiment, the return flow path 48 is divided into a plurality of portions (three portions). However, the return flow path 48 may be a single flow path. In addition, the return flow path 48 can also be applied to the expansion turbine 100 (Embodiment 1) in which no baffle 45 is provided.

The return flow path 48 can be connected to a component disposed downstream of the turbine diffuser 30. Such a component may be a pipe or a freezer. In addition, the return flow path 48 may be a flow path allowing communication between the separation chamber 42 and the internal flow path 30f of the turbine diffuser 30, or may be a flow path allowing communication between the separation chamber 42 and the flow path member 40 contiguous with the turbine diffuser 30.

[4-2. Operation]

The operation and the action of the expansion turbine 400 configured as described above will be described below.

Condensed water separated from the working fluid flows into the groove 52 along the inner surface of the separation chamber 42 by being pressed by the working fluid. Since the downstream portion 44 of the separation flow path 50 is connected to the groove 52, the condensed water is carried to the downstream portion 44 along the groove 52 by the pressure in the separation chamber 42 and gravity and discharged to the outside of the expansion turbine 400. The working fluid is less likely to come into contact with the condensed water flowing in the groove 52, so that the condensed water is less likely to be remixed into the working fluid before the working fluid returns to the main flow F1.

### [4-3. Effects Etc.]

In the present embodiment, the expansion turbine 400 may further include the return flow path 48 which merges the working fluid that has flowed into the separation flow path 50, into the main flow F1 of the working fluid.

The groove 52 prevents condensed water separated from the working fluid from remerging into the working fluid in a path to the downstream portion 44 of the separation flow path 50. This is particularly effective when the working fluid is returned to the main flow F1. That is, frost formation on the inner wall surface of the component disposed downstream of the expansion turbine 400 can be further suppressed.

The working fluid remerges into the main flow F1 through the return flow path 48. With the return flow path 48, cold does not have to be discarded to the outside, and thus the efficiency of the expansion turbine 400 is improved.

In the present embodiment, the return flow path 48 may open toward the separation chamber 42 at the downstream of the baffles 45. With such a configuration, the working fluid from which condensed water is sufficiently removed can be returned to the main flow F1.

In the present embodiment, the separation chamber 42 may have the first inner surface 42p, the second inner surface 42q, and the annular or arcuate groove 52 provided on the first inner surface 42p. The first inner surface 42p and the second inner surface 42q are each a surface along the circumferential direction around the rotation axis O of the expansion turbine impeller 10. The distance from the rotation axis O to the second inner surface 42q is shorter than the distance from the rotation axis O to the first inner surface 42p. At the annular or arcuate groove 52, the downstream portion 44 of the separation flow path 50 may be connected to the separation chamber 42. With such a configuration, condensed water is easily collected in the groove 52. The condensed water flows along the groove 52 and is discharged to the outside of the expansion turbine 400 through the downstream portion 44 of the separation flow path 50.

### Embodiment 5

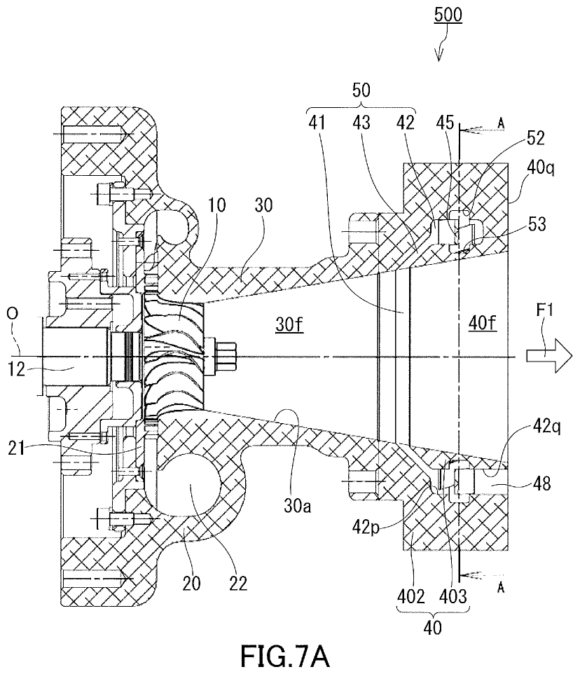

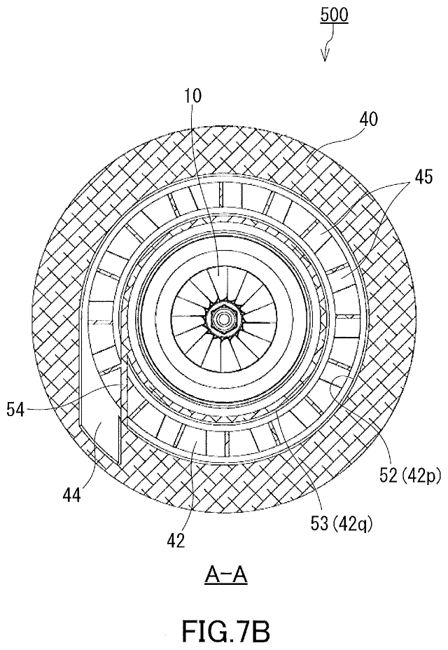

Hereinafter, Embodiment 5 will be described with reference to FIG. 7A and FIG. 7B.

### [5-1. Configuration]

FIG. 7A is a cross-sectional view of an expansion turbine 500 according to Embodiment 5. FIG. 7B is a cross-sectional view of the expansion turbine 500 according to Embodiment 5, taken along a line A-A. As shown in FIG. 7B, the expansion turbine 500 further includes a partition wall 54 disposed in the separation chamber 42. The partition wall 54 extends from the second inner surface 42q to the first inner surface 42p to divide the separation chamber 42, and reaches the downstream portion 44 of the separation flow path 50. The partition wall 54 extends along the tangential direction of the second inner surface 42q. If the partition wall 54 is provided, a flow in one direction toward the downstream portion 44 of the separation flow path 50 is formed in the separation chamber 42. Condensed water is guided to the downstream portion 44 by the flow in the one direction.

The separation chamber 42 further has an annular or arcuate groove 53 provided on the second inner surface 42q. Condensed water flows along the groove 53 and is discharged to the outside of the expansion turbine 500 through the downstream portion 44 of the separation flow path 50.

The partition wall 54 extends from the groove 53 toward the downstream portion 44 of the separation flow path 50. That is, the partition wall 54 bridges the groove 53 and the downstream portion 44. Due to a combination of the action of the groove 53 and the action of the partition wall 54, condensed water is easily collected in the downstream portion 44.

The separation chamber 42 also has the groove 52 described in Embodiment 4. Therefore, the effect of the groove 52 is also obtained. However, the groove 52 may be omitted.

As with the groove 52, the depth of the groove 53 and the width of the groove 53 are not particularly limited. In an example, a depth d3 of the groove 53 with respect to the maximum dimension d1 of the separation chamber 42 in the direction perpendicular to the rotation axis O may be adjusted so as to satisfy (0.4×d1)≤d3≤(0.8×d1). A width w3 of the groove 53 with respect to the maximum dimension w1 of the separation chamber 42 in the direction parallel to the rotation axis O may be adjusted so as to satisfy (0.2×w1)≤w3≤(0.6×w1). The depth of the groove 53 means the depth of the groove 53 in the direction perpendicular to the rotation axis O. The width of the groove 53 means the width of the groove 53 in the direction parallel to the rotation axis O.

The center position of the groove 53 in the direction parallel to the rotation axis O may coincide with the center position of the separation chamber 42 in the direction parallel to the rotation axis O. The center position of the groove 53 in the direction parallel to the rotation axis O may coincide with the center position of each baffle 45 in the direction parallel to the rotation axis O. Accordingly, condensed water can be efficiently separated from the working fluid while the pressure loss of the working fluid is suppressed.

### [5-2. Operation]

The operation and the action of the expansion turbine 500 configured as described above will be described below.

Condensed water separated from the working fluid flows into the groove 52 along the inner surface of the separation chamber 42 by being pressed by the working fluid. Since the downstream portion 44 of the separation flow path 50 is connected to the groove 52, the condensed water is carried to the downstream portion 44 along the groove 52 by the pressure in the separation chamber 42 and gravity and discharged to the outside of the expansion turbine 500. The working fluid is less likely to come into contact with the condensed water flowing in the groove 52.

Similarly, condensed water also flows into the groove 53 on the inner circumferential side of the separation chamber 42. Due to a flow in one direction opposite to the rotation direction of the expansion turbine impeller 10, which is induced by each inclined baffle 45, in addition to the pressure difference between the inside of the separation chamber 42 and the outside, the condensed water flows to the partition wall 54. The condensed water flows along the partition wall 54 and is discharged to the outside of the expansion turbine 500 through the downstream portion 44 of the separation flow path 50.

### [5-3. Effects Etc.]

In the present embodiment, the expansion turbine 500 may further include the partition wall 54 extending from the second inner surface 42q to the first inner surface 42p to divide the separation chamber 42 and reaching the downstream portion 44 of the separation flow path 50. If the partition wall 54 is provided, a flow in one direction toward the downstream portion 44 of the separation flow path 50 is formed in the separation chamber 42. Condensed water is guided to the downstream portion 44 by the flow in the one direction.

In the present embodiment, the separation chamber 42 may further have the annular or arcuate groove 53 provided on the second inner surface 42q. Condensed water flows along the groove 53 and is discharged to the outside of the expansion turbine 500 through the downstream portion 44 of the separation flow path 50.

### Embodiment 6

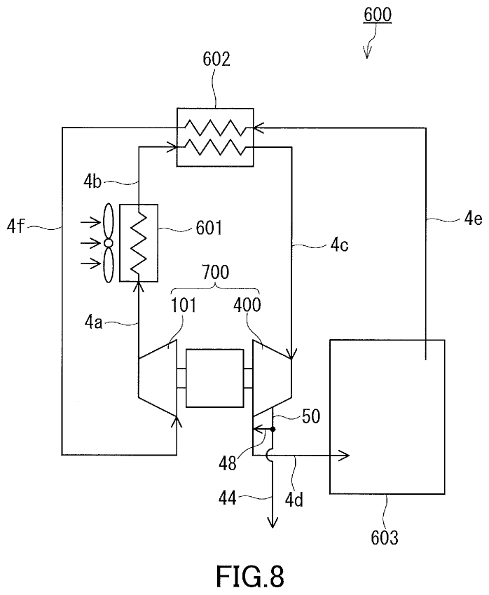

Hereinafter, Embodiment 6 will be described with reference to FIG. 8.

### [6-1. Structure]

FIG. 8 is a schematic diagram of a refrigeration device 600 according to Embodiment 6. The refrigeration device 600 includes a rotating machine 700, a first heat exchanger 601, and a second heat exchanger 602.

The rotating machine 700 has an expansion turbine 400 and a compressor 101. The expansion turbine 400 is the expansion turbine 400 described in Embodiment 4. Instead of the expansion turbine 400, the expansion turbine 100, 200, 300, or 500 of another embodiment may be used. The compressor 101 is, for example, a centrifugal compressor. The rotating machine 700 is configured such that power recovered by the expansion turbine 400 is consumed as a part of the power of the compressor 101.

The first heat exchanger 601 serves to cool a refrigerant (working fluid) by other fluid. The other fluid may be a gas or a liquid. The second heat exchanger 602 is an internal heat exchanger for recovering cold of the refrigerant. Examples of the first heat exchanger 601 and the second heat exchanger 602 include a fin tube heat exchanger, a plate heat exchanger, a double-tube heat exchanger, and a shell-and-tube heat exchanger.

The thermal cycle of the refrigeration device 600 is an air refrigeration cycle in which air is used as the refrigerant. Low-temperature air generated by the refrigeration device 600 is directed to a target space 603. The target space 603 is, for example, a freezer. The refrigeration device 600 may be used for cabin air conditioning in aircraft. Since the global warming potential (GWP) of air is zero, it is desirable to use air as the refrigerant from the viewpoint of global environment protection. Furthermore, by using air as the refrigerant, the refrigeration device 600 can be constituted as an open system.

The rotating machine 700, the first heat exchanger 601, and the second heat exchanger 602 are connected to each other by flow paths 4a to 4f. The flow path 4a connects a discharge port of the compressor 101 and a refrigerant inlet of the first heat exchanger 601. The flow path 4b connects a refrigerant outlet of the first heat exchanger 601 and a high-pressure side inlet of the second heat exchanger 602. The flow path 4c connects a high-pressure side outlet of the second heat exchanger 602 and a suction port of the expansion turbine 400. The flow path 4d connects a discharge port of the expansion turbine 400 and the target space 603. The flow path 4e connects the target space 603 and a low-pressure side inlet of the second heat exchanger 602. The flow path 4f connects a low-pressure side outlet of the second heat exchanger 602 and a suction port of the compressor 101. In the flow paths 4a to 4f, other equipment may be disposed, such as another heat exchanger and a defroster.

The refrigerant compressed in the compressor 101 is cooled in the first heat exchanger 601 and the second heat exchanger 602. The cooled refrigerant expands in the expansion turbine 400. This further decreases the temperature of the refrigerant. The low-temperature refrigerant is supplied to the target space 603 for use for a desired purpose. The refrigerant discharged from the target space 603 is heated in the second heat exchanger 602, and then is introduced into the compressor 101. In an example, the temperature of the refrigerant at the suction port of the compressor 101 is 20° C. The temperature of the refrigerant at the discharge port of the compressor 101 is 85° C. The temperature of the refrigerant at the refrigerant outlet of the first heat exchanger 601 is 40° C. The temperature of the refrigerant at the suction port of the expansion turbine 400 is −30° C. The temperature of the refrigerant at the discharge port of the expansion turbine 400 is −70° C.

The return flow path 48 of the expansion turbine 400 is connected to the flow path 4d. Accordingly, cold does not have to be discarded to the outside, and thus the efficiency of the refrigeration device 600 is improved. Condensed water separated from the working fluid in the expansion turbine 400 is discharged to the outside of the refrigeration device 600 through the downstream portion 44 of the separation flow path 50.

### [6-2. Effects Etc.]

The refrigeration device 600 of the present embodiment includes the expansion turbine 400. In the expansion turbine 400, frost formation in the flow path 4d and the target space 603 can be suppressed. By suppressing frost formation, the downtime of the refrigeration device for defrosting can also be reduced, thereby improving convenience. A mechanism for separating condensed water can be omitted or simplified, thereby reducing the cost of the refrigeration device 600 using the expansion turbine 400.

In the present embodiment, the refrigerant may be air. It is desirable to use air as the refrigerant from the viewpoint of global environment protection. Furthermore, by using air as the refrigerant, the refrigeration device 600 can be constituted as an open system.

### Other Embodiments

As described above, Embodiments 1 to 6 have been described as an illustration of the technique disclosed in the present application. However, the technique according to the present disclosure is not limited to these, and can also be applied to embodiments obtained by making modifications, replacements, additions, omissions, and the like. Furthermore, the components described in Embodiments 1 to 6 above can also be combined to obtain a new embodiment.

Thus, other embodiments will be illustrated below.

The inlet 41 of the separation flow path 50 may be provided in a straight pipe having a constant flow path cross-sectional area. If the working fluid has a swirling component when discharged from the expansion turbine impeller 10, the swirling component is maintained even if the flow path cross-sectional area is constant.

Each baffle 45 may be a flat plate or a perforated plate. In this case, the pressure loss when the working fluid that has flowed into the separation chamber 42 collides against the baffle 45 is reduced.

The baffles 45 may be arranged in a plurality of rows in the direction parallel to the rotation axis O. With such a configuration, condensed water can be more sufficiently collected and discharged.

The above embodiments are for illustration of the technique according to the present disclosure, and accordingly can be subjected to various modifications, replacements, additions, omissions, and the like within the scope of the claims or equivalents thereof.

### INDUSTRIAL APPLICABILITY

The technique of the present disclosure is suitable for separating liquids and solids other than a working fluid from the working fluid. Therefore, the technique of the present disclosure is also applicable to fluid machines other than expansion turbines, such as exhaust gas turbine turbochargers, gas turbine engines, and steam turbine generators.

1. An expansion turbine comprising:
an expansion turbine impeller;
a turbine housing surrounding the expansion turbine impeller in a circumferential direction to form a flow path of a working fluid; and
a turbine diffuser disposed coaxially with the expansion turbine impeller on a discharge side for the working fluid in the turbine housing, wherein
the turbine diffuser also serves as a centrifuge.

2. The expansion turbine according to claim 1, further comprising
a separation flow path that is a flow path having an inlet opening in an inner circumferential surface of the turbine diffuser or an inner circumferential surface of a flow path member contiguous with the turbine diffuser and that communicates with an outside of the expansion turbine.

3. The expansion turbine according to claim 2, wherein
the separation flow path further has a separation chamber located radially outward of the inner circumferential surface of the turbine diffuser or the inner circumferential surface of the flow path member, an upstream portion allowing communication between the inlet and the separation chamber, and a downstream portion allowing communication between the separation chamber and the outside of the expansion turbine.

4. The expansion turbine according to claim 3, wherein
the separation chamber has an annular shape coaxial with the expansion turbine impeller.

5. The expansion turbine according to claim 3, further comprising
a baffle disposed inside the separation chamber.

6. The expansion turbine according to claim 5, wherein
the baffle has a main surface inclined with respect to a rotation axis of the expansion turbine impeller.

7. The expansion turbine according to claim 6, wherein
when viewed in a direction perpendicular to the rotation axis of the expansion turbine impeller, an angle between the rotation axis and the main surface is in a range of 45 degrees or more and less than 90 degrees.

8. The expansion turbine according to claim 3, further comprising
a return flow path configured to merge the working fluid that has flowed into the separation flow path, into a main flow of the working fluid.

9. The expansion turbine according to claim 5, further comprising
a return flow path configured to merge the working fluid that has flowed into the separation flow path, into a main flow of the working fluid, wherein
the return flow path opens toward the separation chamber at downstream of the baffle.

10. The expansion turbine according to claim 3, wherein
the separation chamber has a first inner surface, a second inner surface, and an annular or arcuate groove provided on the first inner surface,
the first inner surface and the second inner surface are each a surface along the circumferential direction around the rotation axis of the expansion turbine impeller,
a distance from the rotation axis to the second inner surface is shorter than a distance from the rotation axis to the first inner surface, and
the downstream portion of the separation flow path is connected to the separation chamber at the annular or arcuate groove.

11. The expansion turbine according to claim 3, wherein
the separation chamber has a first inner surface and a second inner surface,
the first inner surface and the second inner surface are each a surface along the circumferential direction around the rotation axis of the expansion turbine impeller,
a distance from the rotation axis to the second inner surface is shorter than a distance from the rotation axis to the first inner surface, and
the expansion turbine further comprises a partition wall extending from the second inner surface to the first inner surface to divide the separation chamber and reaching the downstream portion of the separation flow path.

12. The expansion turbine according to claim 11, wherein
the separation chamber further has an annular or arcuate groove provided on the second inner surface.

13. The expansion turbine according to claim 1, wherein
the expansion turbine is a radial turbine.

14. A refrigeration device comprising
the expansion turbine according to claim 1, wherein
the working fluid is air.
